(19) United States
(12) Patent Application Publication
(10) Pub. No.: US 2009/0017821 A1
(43) Pub. Date: Jan. 15, 2009

(54) HARD HANDOVER PROTOCOL TO ENSURE THE UCD/DCD AVAILABILITY IN ADVANCE

(76) Inventor: Hyunjeong Hannah Lee, Hillsboro, OR (US)

Correspondence Address: INTEL CORPORATION;c/o INTELLEVATE, LLC, P.O. BOX 52050, MINNEAPOLIS, MN, 55402, US

(21) Appl. No.: 11/776,112

(22) Filed: Jul. 11, 2007

(51) Int. Cl. H04Q 7/20

(52) U.S. Cl. 455/436

(57) ABSTRACT

A technique to improve the synchronization timing of a mobile station (MS) when the MS performs a hard handover (HHO) is provided. An MS is ensured to possess the correct channel descriptor information of a target base station (BS) prior to disconnecting from a current serving BS using minimal control message overhead and thus synchronization latency. Specifically, a channel descriptor information checking procedure is added into the HHO preparation phase. The HHO preparation phase refers to the stage where a handover is initiated but the MS is still connected with the current serving BS.

### BACKGROUND

### Description of the Related Art

WiMAX is an acronym that stands for Worldwide Interoperability for Microwave Access, which is a certification mark for products that pass conformity and interoperability tests for the IEEE 802.16 standard. Wireless broadband access networks, sometimes referred to as WiMAX, generally include one or more base stations (BSs) and one or more mobile wireless stations (MSs).

During operation an MS may transition from a current serving BS to a target BS for various reasons, for example, degraded link characteristics, differing quality of service, and the like. With some types of data and applications, for example, voice over IP (VoIP) and multimedia, transitions between BSs may interrupt service using current techniques due to a series of network re-entry procedures. It is desirable to minimize service disruption time short enough so that performance degradation of delay sensitive applications is unnoticeable.

### BRIEF DESCRIPTION OF THE DRAWINGS

The present invention may be better understood, and its numerous features and advantages made apparent to those skilled in the art by referencing the accompanying drawings.

FIG. 1 illustrates a wireless network operating environment according to some embodiments of the present invention.

FIG. 2 illustrates a message sequence for minimizing synchronization latency according to an embodiment of the present invention.

FIG. 3 illustrates an alternate message sequence for minimizing synchronization latency according to an embodiment of the present invention.

The use of the same reference symbols in different drawings indicates similar or identical items.

### DESCRIPTION OF THE EMBODIMENT(S)

In the following description, numerous specific details are set forth. However, it is understood that embodiments of the invention may be practiced without these specific details. In other instances, well-known methods, structures and techniques have not been shown in detail in order not to obscure an understanding of this description.

References to “one embodiment,” “an embodiment,” “example embodiment,” “various embodiments,” etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

Unless specifically stated otherwise, as apparent from the following discussions, it is appreciated that throughout the specification discussions utilizing terms such as “processing,” “computing,” “calculating,” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data from registers and/or memory to transform that electronic data into other electronic data that may be stored in registers and/or memory. A “computing platform” may comprise one or more processors.

According to current WiMAX based systems, when a mobile station (MS) switches from a current cell with a current serving base station (BS) to a target cell with a target BS through the process of a hard handover (HHO), the MS disconnects from the current BS and performs a series of network re-entry procedures in order to connect with the target BS. During the HHO, there is a service disruption during which the MS cannot send or receive data traffic. It is important to minimize the service disruption such that the performance degradation of delay sensitive applications, for example, voice over IP (VoIP), is unnoticeable.

In the target cell, broadcast information is periodically sent, allowing the MS to synchronize with the target BS. The broadcast information includes an uplink/downlink (UL/DL)-MAP and a channel descriptor (UCD/DCD). UL-MAP and DL-MAP are scheduling information to control the channel access in each frame and thus appear at the beginning of every frame. The latency for an MS to obtain the scheduling information is relatively short, that is, from one to two frame times which may be five to ten msec with frame periodicity of five msec. The target BS also periodically broadcasts the channel descriptor information with a typical periodicity of a few seconds. Thus, the latency for which an MS obtains channel descriptor information can be as long as maximum the broadcast period and in average half of the broadcast period. For instance, even if the broadcast period is 1 sec, the latency can be maximum 1 sec and in average 500 msec. Because the HHO service disruption time should be less than 50 msec or 150 msec depending on the frequency assignment scheme used in a WiMAX system, 500 msec for only synchronization latency is certainly unacceptable.

In order to reduce this synchronization latency, current WiMAX based systems enable every BS to periodically broadcast its neighbor BS's information including channel descriptor settings in its serving area using the MOB_NBR-ADV MAC management message. Hence, an MS may already have the target BS's information through its current BS's broadcast before HHO to the target BS.

Nevertheless, considering that the information is delivered via periodic broadcast, it is still possible that the MS may not own the correct channel descriptor information of the target BS. For example, the channel descriptor information that the MS possesses may be obsolete due to a change from a neighbor BS after the last broadcast. Also, an MS may have missed the previous broadcast for some reason. If the information is incorrect for any reason, the HHO service disruption time would be noticeable to a user. One possible solution is to offer more frequent transmissions of channel descriptor information and/or MOB_NBR-ADV message broadcasts. However, this solution may significantly increase the control message overhead of the entire system because these are large broadcast messages.

According to an embodiment of the present invention, a technique to improve the synchronization timing of an MS when the MS performs a hard handover (HHO) is provided.

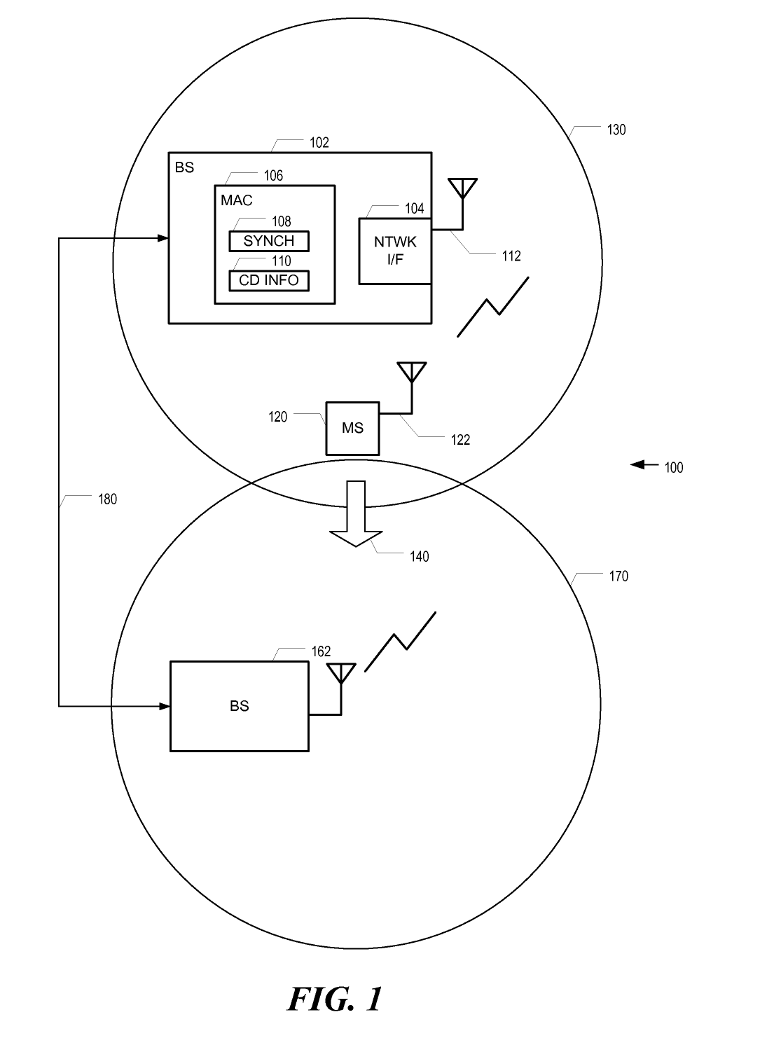

FIG. 1 illustrates a wireless network operating environment 100 in accordance with some embodiments of the present invention. In some embodiments, network operating environment 100 includes a base station (BS) 102 and one or more mobile stations 120 that communicate with BS 102 in a wireless cell 130. Wireless cell 130 may be any type of wireless network, including networks that comply with the Mobile WiMAX, IEEE 802.16e, IEEE 802.16m, 3GPP LTE, 3GPP2 AIE, IEEE 802.20 or other wireless network standards. In some orthogonal frequency division multiplexing (OFDM) and orthogonal frequency division multiple access (OFDMA) embodiments, base station 102 and mobile stations 120 may communicate using multicarrier communication signals comprising a plurality of subcarriers.

Base station 102 may include a wireless network interface 104 and a MAC (Media Access and Control) component 106. MAC 106 may include a synchronizer 108 and channel descriptor information 110 for enabling faster handover process according to embodiments of the present invention. MAC 106 may include other elements (e.g., an UL or a DL scheduler) that are not necessary for an understanding of the embodiments and are therefore not shown to avoid obscuring the description of the embodiments.

In some embodiments, base station 102 may be a wireless access point (AP), such as a Worldwide Interoperability for Microwave Access (WiMax), or broadband communication station, although the scope of the invention is not limited in this respect as base station 102 may be part of almost any wireless communication device. In some embodiments, base station 102 may be a communication station, such as WiMax, or broadband wireless access (BWA) network communication station, although the scope of the invention is not limited in this respect.

Mobile station (MS) 120 may be any type of device that desires to access wireless cell 130 through BS 102. In some embodiments, mobile station 120 may be part of a portable wireless communication device, such as personal digital assistant (PDA), a laptop or portable computer with wireless communication capability, a web tablet, a wireless telephone, a wireless headset, a pager, an instant messaging device, a digital camera, an access point, a television, a medical device (e.g., a heart rate monitor, a blood pressure monitor, etc.), or other device that may receive and/or transmit information wirelessly.

In some embodiments, base station 102 may be referred to as a transmitting station and mobile station 120 may be referred to as a receiving station or subscribing station, however base station 102 may have receiving capability and mobile station 120 may include transmitting capability. Although base station 102 and mobile station 120 are illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, application specific integrated circuits (ASICs), and combinations of various hardware and logic circuitry for performing at least the functions described herein. In some embodiments, the functional elements of base station 102 and mobile station 120 may refer to one or more processes operating on one or more processing elements.

In some embodiments, base station 102 and mobile station 120 may communicate in accordance with specific communication standards, such as the IEEE 802.16-2004 and the IEEE 802.16(e) standards for wireless metropolitan area networks (WMANs) including variations and evolutions thereof, although the scope of the invention is not limited in this respect as they may also be suitable to transmit and/or receive communications in accordance with other techniques and standards. For more information with respect to the IEEE 802.16 standards, please refer to “IEEE Standards for Information Technology—Telecommunications and Information Exchange between Systems”—Metropolitan Area Networks—Specific Requirements—Part 16: “Air Interface for Fixed Broadband Wireless Access Systems,” May 2005 and related amendments/versions.

Antennas 112 of BS 102 and antennas 122 of MS 120 may comprise directional or omnidirectional antennas, including, for example, dipole antennas, monopole antennas, patch antennas, loop antennas, microstrip antennas or other types of antennas suitable for transmission of RF signals. In some embodiments, instead of two or more antennas, a single antenna with multiple apertures may be used. In these embodiments, each aperture may be considered a separate antenna. In some embodiments, antennas 112 and/or antennas 122 may be effectively separated to take advantage of spatial diversity and the different channel characteristics that may result between each of antennas 112 of base station 102 and each of antennas 122 of mobile station 120.

During operation MS 120 may transition from communicating with BS 102 in cell 130 to communicating with BS 162 in target cell 170 for various reasons, for example, degraded link characteristics as MS 120 moves in the direction of arrow 140. Such a transition may be initiated by BS 102 or MS 120. BS 102 and BS 162 may be connected via wired backbone 180 or a wireless interface, not shown. According to an embodiment of the present invention, MS 120 possesses the correct channel descriptor information of BS 162 prior to disconnecting from BS 102 using minimal control message overhead and thus synchronization latency with target BS 162 is minimized. Specifically, a channel descriptor information checking procedure is added into the HHO preparation phase. The HHO preparation phase refers to the stage where a handover is initiated but the MS is still connected with the current BS.

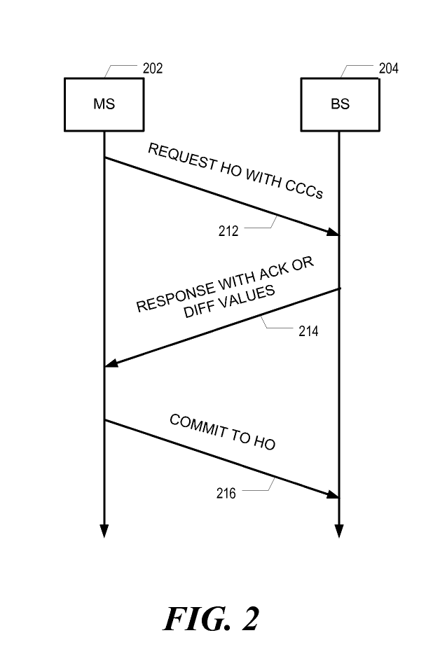

FIG. 2 illustrates a message sequence for minimizing synchronization latency according to an embodiment of the present invention. During the HHO preparation phase, an MS 202 initiates a handover by sending a handover request message to BS 204, at transmission 212. The handover request message may be similar to current WiMAX message MOB_MSHO-REQ, however, it further includes MS 202's current UCD/DCD configuration change count (CCC) values. CCC values are used to index the change of UCD/DCD values.

Upon receiving the handover request message, the current BS 204 verifies the received CCC values. If the values that MS 202 encoded in the message are the same as the values stored by BS 204, BS 204 acknowledges, using, for example, a one bit setting in a response message, at transmission 214. Alternately, if the values are not the same, the BS 204 sends MS 202 the difference between the UCD/DCD setting known to MS 202 and the correct one in the response message, at transmission 214. The response message may be similar to current WiMAX message MOB_BSHO-RSP, however, it further includes either an acknowledgement of correct information or a difference value between the information held by MS 202 and the correct information.

MS 202 then disconnects from BS 204 by transmitting commitment for the handover message, at transmission 216. The commitment for the handover message may be similar to current WiMAX message MOB_HO-IND. Upon sending this message, MS 202 finishes the HHO preparation phase and then begins HHO execution. The service disruption time begins after this message is sent, however, re-connection time is minimized according to embodiments of the present invention because MS 202 is ensured to have correct channel descriptor information for the target BS.

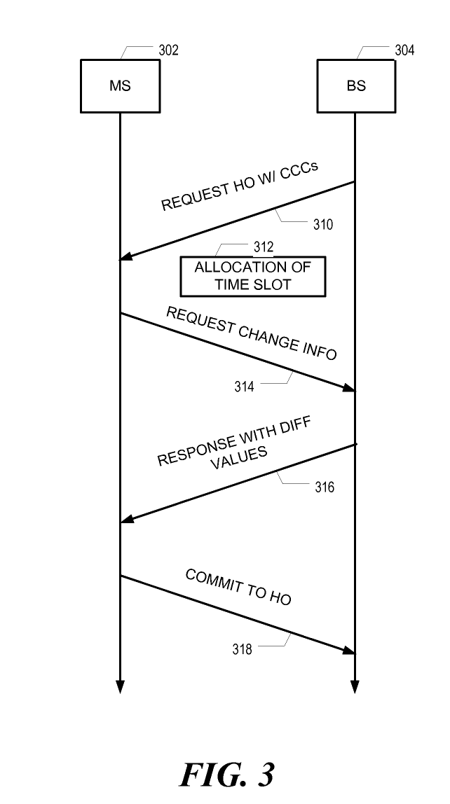

FIG. 3 illustrates an alternate message sequence for minimizing synchronization latency according to an embodiment of the present invention. During the HHO preparation phase, a BS 304 can initiate a handover by BS 304 sending a handover request message to MS 302, at transmission 310. The handover request message may be similar to current WiMAX message MOB_BSHO-REQ, however, it further includes up-to-date UCD/DCD CCCs in the handover request message.

BS 304 schedules an uplink transmission for MS 302 at block 312. The allocation is used by MS 302 either for the transmission of a change information request message, at transmission 314, if there is a CCC value mismatch with the received values in the request message or for the transmission of a handover commit message, at transmission 318. Specifically, if the CCC values sent by BS 304 match those stored by MS 302, MS 302 proceeds the with the handover by sending a handover commit message, similar to current WiMAX message MOB_HO-IND. However, if mismatched, MS 302 transmits a request change message, which may be identified as MOB_CHINFO-REQ, during the allocation, in order to obtain the up-to-date UCD/DCD settings. The request change message includes the CCC values of the potential target BSs based on the current knowledge of MS 302. BS 304 sends a response message at transmission 316, including the difference between the UCD/DCD setting known to MS 302 and the correct setting. Such response message may be identified as MOB_CHINFO-RSP.

Upon receiving MOB_CHINFO-RSP, MS 302 sends a handover commit message at transmission 318 and disconnects from BS 304. The commitment for the handover message may be similar to current WiMAX message MOB_HO-IND. Upon sending this message, MS 302 finishes the HHO preparation phase and then begins HHO execution. The service disruption time begins after this message is sent, however, reconnection time is minimized according to embodiments of the present invention because MS 302 is ensured to have correct channel descriptor information for the target BS.

Embodiments of the invention may be used in a variety of applications. Some embodiments of the invention may be used in conjunction with various devices and systems, for example, a transmitter, a receiver, a transceiver, a transmitter-receiver, a wireless communication station, a wireless communication device, a wireless Access Point (AP), a modem, a wireless modem, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a network, a wireless network, a Local Area Network (LAN), a Wireless LAN (WLAN), a Metropolitan Area Network (MAN), a Wireless MAN (WMAN), a Wide Area Network (WAN), a Wireless WAN (WWAN), devices and/or networks operating in accordance with existing IEEE 802.11, 802.11a, 802.11b, 802.11e, 802.11g, 802.11 h, 802.11i, 802.11n, 802.16, 802.16d, 802.16e standards and/or future versions and/or derivatives and/or Long Term Evolution (LTE) of the above standards, a Personal Area Network (PAN), a Wireless PAN (WPAN), units and/or devices which are part of the above WLAN and/or PAN and/or WPAN networks, one way and/or two-way radio communication systems, cellular radio-telephone communication systems, a cellular telephone, a wireless telephone, a Personal Communication Systems (PCS) device, a PDA device which incorporates a wireless communication device, a Multiple Input Multiple Output (MIMO) transceiver or device, a Single Input Multiple Output (SIMO) transceiver or device, a Multiple Input Single Output (MISO) transceiver or device, a Multi Receiver Chain (MRC) transceiver or device, a transceiver or device having “smart antenna” technology or multiple antenna technology, or the like. Some embodiments of the invention may be used in conjunction with one or more types of wireless communication signals and/or systems, for example, Radio Frequency (RF), Infra Red (IR), Frequency-Division Multiplexing (FDM), Orthogonal FDM (OFDM), Time-Division Multiplexing (TDM), Time-Division Multiple Access (TDMA), Extended TDMA (E-TDMA), General Packet Radio Service (GPRS), Extended GPRS, Code-Division Multiple Access (CDMA), Wideband CDMA (WCDMA), CDMA 2000, Multi-Carrier Modulation (MDM), Discrete Multi-Tone (DMT), Bluetooth (RTM), ZigBee (TM), or the like. Embodiments of the invention may be used in various other apparatuses, devices, systems and/or networks.

The techniques described above may be embodied in a computer-readable medium for configuring a computing system to execute the method. The computer readable media may include, for example and without limitation, any number of the following: magnetic storage media including disk and tape storage media; optical storage media such as compact disk media (e.g., CD-ROM, CD-R, etc.) and digital video disk storage media; holographic memory; nonvolatile memory storage media including semiconductor-based memory units such as FLASH memory, EEPROM, EPROM, ROM; ferromagnetic digital memories; volatile storage media including registers, buffers or caches, main memory, RAM, etc.; and data transmission media including permanent and intermittent computer networks, point-to-point telecommunication equipment, carrier wave transmission media, the Internet, just to name a few. Other new and various types of computer-readable media may be used to store and/or transmit the software modules discussed herein. Computing systems may be found in many forms including but not limited to mainframes, minicomputers, servers, workstations, personal computers, notepads, personal digital assistants, various wireless devices and embedded systems, just to name a few. A typical computing system includes at least one processing unit, associated memory and a number of input/output (I/O) devices. A computing system processes information according to a program and produces resultant output information via I/O devices.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. A method comprising:
sending channel descriptor configuration change count values of a potential target base station with a handover request.

2. The method as recited in claim 1, wherein the channel descriptor configuration change count values index the change of uplink and downlink channel description settings.

3. The method as recited in claim 1, wherein the handover request is from a mobile station to a current base station.

4. The method as recited in claim 3, wherein upon a mismatch of the channel descriptor configuration change count values and correct values, receiving a difference between the channel descriptor configuration change count values and the correct values from the current base station.

5. The method as recited in claim 3, wherein upon a match of the channel descriptor configuration change count values to correct values receiving an acknowledgement of correct values in a response.

6. The method as recited in claim 3, further comprising sending a commit to handover message.

7. The method as recited in claim 1, wherein the handover request is from a current base station to a mobile station.

8. The method as recited in claim 7, wherein upon a mismatch of the channel descriptor configuration change count values and current values, receiving a request including an identification of a potential target base station.

9. The method as recited in claim 8, further comprising sending correct channel descriptor setting information for the target base station.

10. The method as recited in claim 7, further comprising receiving a commit to handover message.

11. A machine-readable medium having machine executable instructions for performing a method, the method comprising:
sending channel descriptor configuration change count values of a potential target base station with a handover request.

12. The machine-readable medium as recited in claim 11, wherein the channel descriptor configuration change count values index the change of uplink and downlink channel description settings.

13. The machine-readable medium as recited in claim 11, wherein the handover request is from a mobile station to a current base station.

14. The machine-readable medium as recited in claim 13, wherein upon a mismatch of the channel descriptor configuration change count values and correct values, the method comprising further receiving a difference between the channel descriptor configuration change count values and the correct values from the current base station.

15. The machine-readable medium as recited in claim 13, wherein upon a match of the channel descriptor configuration change count values to correct values the method further comprising receiving an acknowledgement of correct values in a response.

16. The machine-readable medium as recited in claim 17, wherein upon a mismatch of the channel descriptor configuration change count values and current values, the method further comprising receiving a request including an identification of a potential target base station.

17. The machine-readable medium as recited in claim 18, the method further comprising sending correct channel descriptor setting information for the target base station.

18. An apparatus comprising:
a MAC component create a message to send channel descriptor configuration change count values of a potential target base station with a handover request;
a network interface coupled to the MAC component to send the message via an antenna.

19. The apparatus as recited in claim 18, wherein the channel descriptor configuration change count values index the change of uplink and downlink channel description settings.

20. The apparatus as recited in claim 18, wherein the handover request is from a current base station to a mobile station.

21. The apparatus as recited in claim 20, wherein upon a mismatch of the channel descriptor configuration change count values and current values, the network interface to receive a request including an identification of a potential target base station.

22. The apparatus as recited in claim 21, the MAC component further to create a message to send correct channel descriptor setting information for the target base station.
